(19) United States
(12) Patent Application Publication
(10) Pub. No.: US 2003/0110182 A1
(43) Pub. Date: Jun. 12, 2003

(54) Multi-resolution image management system, process, and software therefor

(76) Inventors: Gary Christophersen, Vashon, WA (US); Daniel J. Sanow, Auburn, WA (US); Karl Brian Bond, Mill Creek, WA (US)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 09/834,395

(22) Filed: Apr. 12, 2001

Related U.S. Application Data
(60) Provisional application No. 60/196,747, filed on Apr. 12, 2000.

(51) Int. Cl. G06F 7/00

(52) U.S. Cl. 707/104.1

(57) ABSTRACT

The invention comprises a system, method, and software for selectable, inverse hierarchical management and archival storage of multi-resolution images on multiple storage media for faster access and rendering of the images for electronic and/or print reproduction and distribution. Digital images typically acquired by scanning in Full Resolution (FR) size are organized into logical groups, or rolls. Smaller Screen Size (SCR), Preview (PV), and Thumbnail (TN) size proxy images are created, ranked by resolution, hierarchically and inversely stored with the smaller, lower resolution image files on the fastest media (hard drives) and higher resolution files on the slowest storage/retrieval media (optical or tape drives). This significantly improves effective image density and speeds on screen image retrieval and rendering.

### RELATED APPLICATION

This application is related to and claims priority of Provision Application Serial No. 60/196,747 filed Apr. 12, 2000 under 35 USC §119.

### FIELD OF THE INVENTION

This invention relates to a system, method, and software for selectable, inverse hierarchical, management and archival storage of multi-resolution images on multiple storage media for faster access and rendering of the images for electronic and/or print reproduction and distribution, and more particularly for back office management of digital image, acquisition, transfer, archiving, and retrieval for distribution of selected size images over the Internet and ordering of image products via the Internet.

### BACKGROUND

Since at least as early as mid-1994, digital images that have been acquired from a variety of sources (i.e., scanned from photographs or developed film, downloaded from digital cameras, or transferred from tapes, hard drives, or other media, and the like) have been made available to selected individuals or the public via HTTP (“web”) servers connected to the Internet. Of course, the image-hosting websites need to be profitable to survive, so the strategy has been to sell photo-related products, such as prints, novelty items, mementos, and the like, to cover the image archiving costs. Further, in order to make such products of interest to customers, the digital images from which the products are created must be high resolution, photo quality images.

Storing such high-resolution digital images gives rise to several problems. Currently, acquired electronic images are stored digitally in a variety of media storage devices, including spinning disks, optical storage media (CD ROMs, re-writable CDs, DVDs, and similar media), and tapes. Each such storage device or platform has its own unique operational characteristics, including driver software, archival integrity, write time, access (read) time, storage density, sensitivity to handling, cost, and the like. Accordingly, server-management system architecture typically involves operation of a bank of identical or similar types of storage media to achieve back office efficiency and simplicity of management, while using generic database software for recording the addresses of the several identical storage device archives.

However, such archival systems are not tuned to the needs of Internet users, who typically have relatively small screen display areas for photographs, and a wide variety of marginally compatible, at best, computer platforms, including diverse monitors, CPUs, software, modems/DSL/ISDN/cable/wireless or other data connection devices, and service providers. On the Internet, time is costly, and slow loading of images is a serious turn-off for customers. Currently, there are extensive delays while frames on web pages await the archival retrieval of the selected images stored on slow media, and more time is lost in the transmission and slowness of ultimate line-by-line display (rendering on the user's screen). ISP service interruptions (loss of connection) often means that images are lost in mid- download, so that the user has to start over, or simply quits in discouragement or disgust.

These delays are severely exacerbated where the remote user (or customer) is provided direct access to large images; such file sizes may be too large to transfer via free e-mail services, and at best, can cause significant delays to downloading large files to the customer's computer over a common dial-up connection. Further, the large image size cannot be displayed in its entirety on a typical customer display. Finally, providing the full-sized image to the customer destroys the site's value, as so doing provides the customer the high-resolution images that could be supplied to competing vendors for production of high quality prints or products. The initial cost of scanning and archiving the high-resolution image cannot be recovered by the initial photo-service vendor by such file sharing.

Accordingly, there is a need in the art to provide a back office hardware and software image management system to allow fast retrieval of a variety of differently sized images by customers, as well as to allow product ordering by the customer without providing the customer with the means to circumvent the providing-company from fair recovery of scanning and archival costs.

### THE INVENTION

### SUMMARY, OBJECTS AND ADVANTAGES

It is among the objects and advantages of the invention to provide a back office multi-resolution image management system, including hardware, its architectural configuration and interconnection topology, and management software, for faster archival storage, retrieval, and delivery of images to Internet servers for upload to Internet users. Throughout the application, reference will be to the exemplary user being a subscriber to, customer of, or client of, a photo processing or image bank service, such as, but not limited, to an individual who sends “film” to a third party (typically remote) processor for developing and printing. By way of example, the user would be a customer of a processing service that offers electronic image download services, such as “Photomail®”, a service of PhotoWorks Inc. of Seattle, Wash., (formerly, Seattle FilmWorks Inc.). Such a service allows an electronic digital image file version of the customer's developed film to be viewed via the Internet through authorized access to the PhotoWorks web site.

The present invention provides complete back office digital image management, including the acquisition, archiving, handling, retrieval, and delivery to the Internet servers at lower cost yet at substantially faster rates than presently available by generic storage systems. The inventive multi-resolution digital image management system is transparent to the customers. As has been the case since early 1994, customers send in rolls of undeveloped film to the processor, the film is developed and scanned by high-resolution scanners, and digital images are placed on the processor's web site. Customers will also be able to transfer images to the webserver from their computers, which is especially useful in the case of customer-scanned or otherwise acquired digital images.

The inventive multi-resolution digital image management system and method of image storage, in the preferred embodiment, facilitates and permits substantially faster downloading and rendering of the images by selectively storing the digital image files on different types and speeds of multiple different storage media platforms. The images are ranked by resolution, hierarchically and inversely, with the smaller, lower resolution images (image files) being stored on the fastest media, and the highest-resolution images being stored on the slowest storage/retrieval media.

While this inverse hierarchy is counter-intuitive, surprisingly we have found that the resulting effective image density on the faster media is greater, which mirrors the needs of the real world. That is, Internet enabled customer viewing is optionally and preferably limited under the process of the invention to selected lower or mid-resolution images. This selective availability permits more customers faster access to their selected images, while maintaining sufficient detail for the customers to select and complete their specific transaction needs (e.g., printing and/or forwarding images and/or orders).

Thus, pursuant to the invention, the highest resolution image files from which the digital image prints, products, or other reproductions are made, or which are distributed electronically, are stored on the slower storage media devices, where “traffic” is slower or where real-time access to the images is not necessary. Thus, the hierarchy of the invention may be characterized as related to the anticipated traffic for a given resolution size, larger file sizes being put onto slower media. Additionally, the Internet or image management server can restrict or prevent access to the “full size” image files to preserve the added value.

Since the typical image to be displayed will be a small-resolution “proxy” of the original image, the effective display speed is greatly enhanced, permitting very fast access by vast numbers of customers to Thumbnail (TN) and preview (PV) sized images. A significant advantage of the inventive image management system and process is the consolidation of images from a specific “source” into a single storage file, thus facilitating more efficient storage utilization. By “source”, as described in more detail below, is meant, e.g., a related group or set of images, such as fro a roll of film. Since the system and process only reads a single file in order to access the images contained in it, the resultant system speed is dramatically improved.

Throughout, and by way of example only, the invention will be described in terms of a roll of conventional developable film being received from a customer by the processing service and developed. Thereafter, the developed negatives or slides, preferably while still in uncut strip form, are scanned with a high-resolution scanner to form a “roll-related” set of multiple digital images of at least one resolution, preferably Full Resolution. Then, multiple different resolution proxy digital images are derived from the FR images by the inventive software system, Hierarchical Storage Management (HSM) system, and stored. The storage preferably includes different storage media platforms for storage of images on which are selectable in relation to, depending on the retrieval speed needs necessary for a given type of image size file. Thus, as the image size becomes larger, the time to recover and render them becomes longer. While the inventive system may provide all resolution sizes available for viewing by the customer, the present best mode process calls for only selected sizes being viewable on the Internet.

The current best mode of the invention manages three or more image sizes: TN images of approximately 96×64 pixels in size; PV images of approximately 384×256 pixels; Screen Size (SCR) images of approximately 768×512 pixels; and Full Resolution (FR) images of SCR size or larger, currently 1536×1024. TN, PV, and optionally SCR images are selectively accessible and viewable by the customer, while larger sizes (SCR and/or FR) are reserved for further processing (like printing). The viewable size images (TN, PV, and optionally SCR) are selectively stored on the fastest media, pursuant to the invention, currently hard disc drives, which have delivery and display times (retrieval and rendering times) on the order of 4 seconds or less.

SCR images, currently the largest available for viewing on the Internet, at 768×512 pixels, are stored on magneto-optical media, such as read-write CD storage systems which deliver images in about 12 seconds. The FR images are stored on tape drives, having access and delivery (rendering) times of approximately 30 seconds. A typical digital image storage system of a photo processor is approximately 60 terabytes, with the different media storage-device quantities being distributed among that exemplary total in accord with demand requirements. A typical set of images (averaging twenty-two images, corresponding to a 35 mm roll of film) of TN images is about 130 KB, while a set of corresponding PV images will be approximately 400 Kb. Various image storage formats (such as Joint Photographic Experts Group) and compression methods may be employed.

The digital image management system of the invention preferably manages the images in defined sets (typically corresponding to processed rolls of film or sets of uploaded images), so that when the customer identifies his or her selected roll, the system can display all TN images in the set in a matrix on the user's Internet computer screen. Since the customer-related (associated) images are managed as rolls (the associated group being called a “roll”), the display time for any given roll is essentially identical to any other roll of the same customer or any other customer's rolls. When the user selects an identified TN to “view” in PV resolution, by clicking on the screen-rendered TN via a flyover, only that single PV sized image is downloaded for viewing. When the customer selects that image, or selects several images during browsing, for hardcopy printing, the inventive image management process operates in the background, transparent to the customer. The inventive software carries the HSM server to access the slower (slowest) storage media (tape) on which the highest resolution image files are stored (e.g., the FR images are accessed by the processing service). The prints are made from the FR images for distribution to the customer or his or her preselected recipient(s). The customer thus never sees nor accesses the FR files, which remain the prime archival files for quality reproduction of the images. Note also that multiple copies of the image may simultaneously reside on different storage media devices, typically run by different, albeit interconnected, servers under the image management software of this invention, thus providing redundancy for 100% access of images by the respective authorized person, i.e., the customer or authorized viewer, and the processing or printing service provider.

An imaging program, which may be the same proxy image creation program used initially to create the various resolution images, may be employed by the inventive system in selected cases where the TN or PV images need to be reconstructed from a larger image file. This software functions to copy the FR images, while resizing and reducing them in resolution. Thus, the image management software of the invention recreates the SCR, PV, and TN images when the customer attempts to access an image that (for one or more reasons) no longer has low and medium resolution copies available. Reasons for lower resolution image-unavailability include, among others: deletion of low-resolution images to save space where images have not been accessed in a long time; computer or storage media failure or defect; program errors; and the like. The customer receives a screen notification that the images will be available for viewing shortly, and a “loading” progress bar may be displayed.

The inventive photo management and archival storage system offers image management services to customers who access the services via the Internet using various computer devices, such as laptops, desktop computers, handheld computers, network computers, and the like, over land lines, satellites or wireless connections. The inventive management and archival storage system facilitates the distribution and processing of customer images. The inventive system associates preferences, account information, tracking information about image viewing histories, and many other such data with the individual customers.

The objects and advantages of the Internet-based photo management and archival storage services of the invention include: facilitation of back office image management, fast archival storage, retrieval, and delivery of images, both physically and across the Internet.

The invention includes a full computer system for the management of the images and the archival system, communications, database operations, history tracking and reporting, processing, and billing. The hosting site facilitates customer management and archiving of the customer images and further provides communication tools to generate image files, transmit images, receive images, archive images, search for images, order image related products, and personalize the customer's view of the website.

The processes underlying the site operation, communications with site visitors, and the Internet-implemented management and archival system as described herein may be implemented in software as computer-executable instructions that upon execution perform the operations illustrated in the several figures and described herein. The webserver(s) of the inventive system may be implemented as one or more computers, configured with server software to host a site on the Internet, to serve static, generally informational Web pages, and to generate and serve dynamic Web pages showing arrays of customer TN images or specific image files, tailored to facilitate the delivery of the services and methodology described herein. The dynamic web pages are tailored to individual customers and may be generated on the fly in response to individual requests from customers via their Internet linked access devices (desktop and laptop computers, network computers, etc.).

The computer(s) of the invention can be configured in a system architecture, for example, as one or more server computer(s), database (both relational and hierarchical) computer(s), storage computer(s), routers, interfaces, and peripheral input and output devices, that together implement the system and network. A computer used in the inventive system typically includes at least one processor and memory coupled to a bus. The bus may be any one or more of any suitable bus structures, including a memory bus or memory controller, peripheral bus, and a processor or local bus using any of a variety of bus architectures and protocols. The memory typically includes volatile memory (e.g., RAM) and fixed and/or removable non-volatile memory. The non-volatile memory can include, but is not limited to, ROM, Flash cards, hard disk drives including drives in RAID arrays, floppy discs, mini-drives, Zip drives, Memory sticks, PCMCIA cards, tapes, optical drives such as CD-ROM drives, WORM drives, RW-CDROM drives, etc., DVD drives, magneto-optical drives, and the like. The various memory types provide for storage of information and images, including computer-readable instructions, data structures, program modules, operating systems, and other data used by the computer(s).

A network interface is coupled to the bus to provide an interface to the data communication network (LAN, WAN, and/or Internet) for exchange of data among the various site computers, routers, customer computing devices, and product vendors. The system also includes at least one peripheral interface coupled to the bus to provide communication with individual peripheral devices, such as keyboards, keypads, touch pads, mouse devices, trackballs, scanners, printers, speakers, microphones, memory media readers, writing tablets, cameras, modems, network cards, RF, fiber-optic, and IR transceivers, and the like.

A variety of program modules can be stored in the memory, including OS, server system programs, HSM system programs, application programs, and other program modules and data. In a networked environment, the program modules may be distributed among several computing devices coupled to the network, and used as needed. When a program is executed, the program is at least partially loaded into the computer memory, and contains instructions for implementing the operational, computational, archival, sorting, screening, classification, formatting, rendering, printing and communication functions and processes described herein.

The customer, image relationship, use, and other such data are stored in one or more sets of data records, which can be configured as a relational database (hierarchical, network, or other type of database as well) in which data records are organized in tables. Such records may be selectively associated with one another pursuant to predetermined and selectable relationships, so that, for example, data records in one table are correlated to corresponding records for the customers in another table and the correlation or individual datum is callable for rendering on screen, printout or other activity pursuant to the inventive method and system.

### BRIEF DESCRIPTION OF THE DRAWINGS

The invention is disclosed in more detail in the drawings, in which:

FIG. 1 is a general schematic showing the context of industrial applicability of the invention, including the inter-relationships of various aspects of the invention;

FIG. 2 is a schematic of the process of uploading images onto the inventive system;

FIG. 3 is a schematic of typical image retrieval and display to a customer over the Internet; and

FIG. 4 is a schematic demonstrating the process of requesting an image on a product and the resulting product, in this case, a request for a print of an image and the image being printed.

### DETAILED DESCRIPTION, INCLUDING THE PRESENT BEST MODES OF CARRYING OUT THE INVENTIONS

The following detailed description illustrates the invention by way of example, not by way of limitation of the principles of the invention. This description will clearly enable one skilled in the art to make and use the invention, and describes several embodiments, adaptations, variations, alternatives, and uses of the invention, including what is presently believed to be the best modes of carrying out the invention.

In this regard, the invention is illustrated in one or more figures, and is of sufficient complexity that the many parts, interrelationships, and sub-combinations thereof simply cannot be fully illustrated in a single patent-type drawing. For clarity and conciseness, drawings may show in schematic, or omit, parts elements or system components that are not essential in that drawing to a description of a particular feature, aspect or principle of the invention being disclosed. Thus, the best mode embodiment of one feature may be shown in one drawing, and the best mode of another feature will be called out in another drawing. It should also be understood that although the figures illustrate the process in terms of devices and image data flow paths between them, one skilled in the art, working with the disclosure herein, is easily able to comprehend and use the inventive process in terms of conventional software functionality and logic flow diagrams or schematics.

All publications, patents, and applications cited in this specification are herein incorporated by reference as if this application specifically stated that each individual publication, patent, or application was incorporated by reference.

In the current best mode, an account is set up, typically in advance of the creation of the image files. This is done either: 1) by the customer through a data input form on the company's web site, or 2) automatically by the inventive image management system at the processor's site when a roll is received from a customer who does not have an account. Once an account is created for a particular customer, image files may be associated with that customer's account.

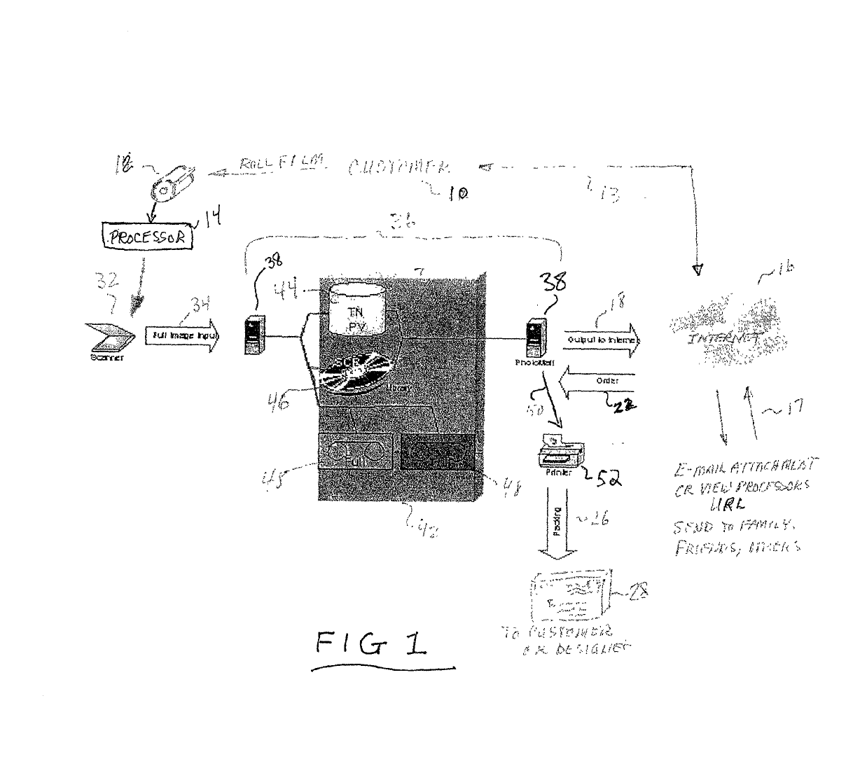

FIG. 1 shows a simplified schematic of the overall inventive system within the context of a photo processor accessible by a customer via the Internet. Although the figure is merely exemplary, it clearly illustrates the use of context of the inventive system 36 in an Internet environment. Customer 10 takes pictures and provides roll film 12 to a processor 14, which develops and scans the film. The scanner (32) is typically a negative film scanner at the film-processing lab. However, the scanner (32) may also be at the customer's location (i.e., a home or office scanner), or any other source of image files, including, but not limited to, a customer's digital camera, a PhotoCD, or other sources of digital image files. The scanner (32) converts the images into image files of as high a resolution as possible, preferably at least the FR resolution. The scanner then forwards (34) the image data files to the gateway server (38) of the inventive system 36, which includes the inventive inheres hierarchical image management software which determines where to appropriately store the images. The gateway server (38) serves a variety of system operation functions, including but not limited to, being a webserver, an image router and/or consolidator, or a production manager or controller. Moreover, the gateway server 38, is not necessarily a single server or in a single location. For example, for simplicity of discussion, the hardware and software are treated as functionally identical, although one skilled in the art appreciates that the software includes the instruction sets that cause the hardware to carry out the various data acquisition, transfer, management, archiving, retrieval, and production functions described herein. One so skilled in the art would also recognize that server 38 is identified on both the left (input) end of the inventive system 36, and the right (output) end, and could be the same hardware and software, or could be a different, separate device.

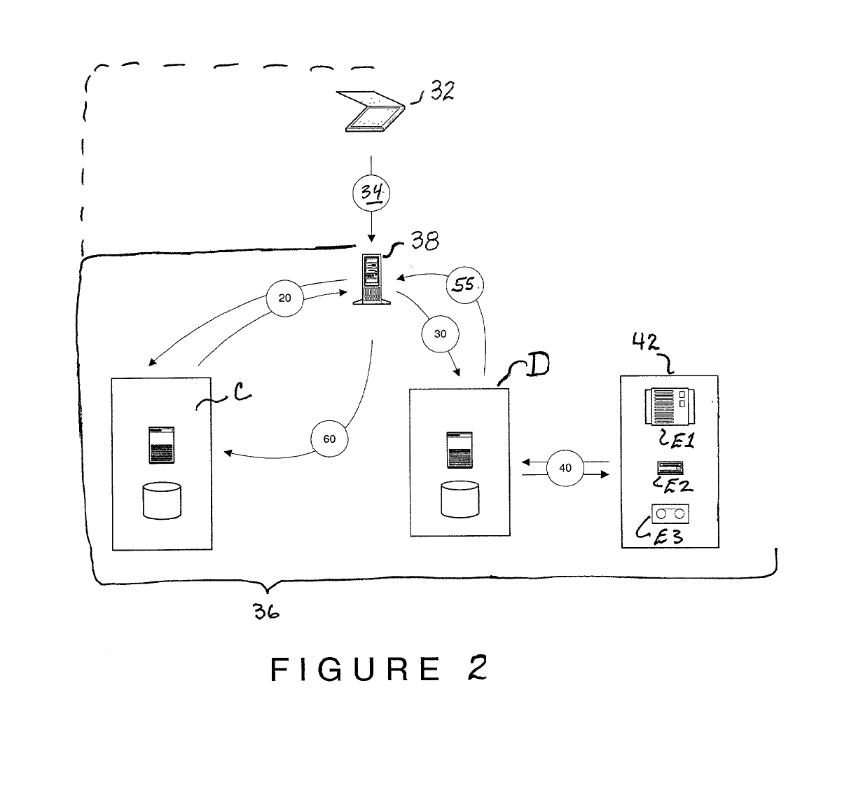

Once the gateway server (38) receives the high-resolution images, the image router/consolidator aspect of the inventive management software determines where to store the images. FIG. 2 more fully shows the specific storage process for the image files; the figure is described in detail below. Continuing with FIG. 1, the images are selectively routed to and addressably archived in the multi-platform image storage drives (42) in inverse hierarchical order. The exemplary inventive system (36) selectively stores the TN and PV images on disk drives (44), the SCR images on optical media (46) and the full images on tapes (48). FIG. 1 also shows that a customer 10 can then access the TN and PV images over the Internet (16). The gateway server (38) can provide selected image files from the appropriate drives 44, 46 of the image storage (42) upon request (17) by the customer. The gateway server (38) can also process order 22 from the customer, send the image file for reproduction on or in a product, such as a professional photo quality printer (52) The product prints are packaged (26) and sent (28) to the customer 10. The customer can also instruct the server 38 to send (17) selected images to third parties via e-mail pr link back to the digital image archive 42.

FIG. 2 shows in detail the inventive process from the acquisition of digital image files at the scanner (32) to their storage. The image files acquired at scanner (32) are sent (34) under an Image File name to the gateway server (38) where the image files are logically grouped (consolidated) (i.e., as a “roll”) by a consolidation module of the inventive management software. This functionality may be facilitated, for example, by the start and end roll scan data (signature), which includes an associated customer identifier (e.g., a customer number input by an operator, scanned roll bar code, or the like.) The Image Consolidation Module requests (20) a Storage File name from the Image Database (C). The Image Consolidation Module indexes (associates) with the Image file name received from the Scanner (32, 34). The Image Database (C) provides (20) a file storage name to the Image Consolidator module at the gateway server (38), which then consolidates each roll (set) of like-sized images into a single storage file. A specific file name extension is given by the Consolidation Module to each file containing specific image sizes. For example, a file containing TN images is given the extension “.TNS,” and a file containing Screen images is given the extension “.SCR.” The gateway server then forwards (30) the images and the associated storage names to the HSM software module (D). The HSM (D) software module of the inventive system determines on which storage media (42), E1, E2, or E3, to place each image file according to the specified rules.

In cases where customers send images directly, rather than a professional processor scanning and sending the images, the customer images are preferably in the highest resolution that the customer can supply. The customer-supplied resolution is the highest resolution that will be available in the future from the image archive. Of course, that resolution may not be as high quality as the FR image files. Based on the resolution of the customer provided image files, the system software creates the lower various proxy images as described above.

The HSM software functions to select, route, and places each type of file on specific storage media in inverse hierarchical order based upon the file name extension. The HSM (D) routes the TN and PV files to fast-access media (42, E1) and the larger images to one or more different types of slower-access media (Optical Drive, E2, or Tape, E3). The HSM (D) forwards (40) the image files to the appropriate storage media into the archive 42. The HSM (D) confirms (55) to the gateway server/image consolidator (38) that the image files have been successfully stored pursuant to the inverse hierarchical order algorithm. The gateway server/image consolidator (38) updates (60) the Image Database (C), adding notations to the database that indicate that the files are in storage, what their file names are and storage media or location.

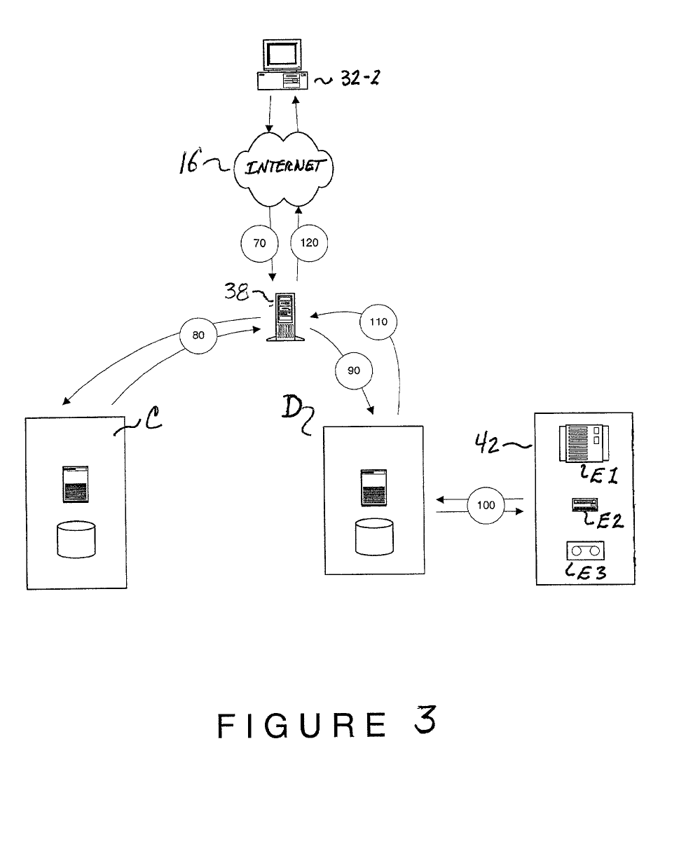

FIG. 3 shows the typical process through which a customer orders display of images via the webserver for viewing from the customer's location (i.e., from home). The customer uses a computer device (32-2) to access the Internet (16). The customer's request (70) is routed through the Internet to arrive at the gateway server (38), here being used in its webserver capacity. The gateway server/webserver (38) authenticates and/or validates the request (80) with the Image Database (C). If the request is a valid one for a valid image or set of images, the webserver requests the consolidated image file(s) from the HSM system (D). As described above, depending on the optional configuration, the inventive system retrieves (100) images from the archive (42) and makes them available to the user in one or more of four image sizes: TN, PV, SCR, and FR. In the current best mode, the TN images should be accessible by the customer via the Internet within a few minutes to a few hours after receipt-in of the customer's film, processing, and scanning by high-resolution scanner. Upon customer's request, where the image files are in the archive 42, the rendering of TN and PV images on the customer's screen is only a few seconds.

The database (C) is also useful for use-history tracking, image popularity, and other such information. Such information is recorded during “calls” to the database by the gateway server/webserver (38), the image consolidator (B), etc. The tracking and history data is not limited to usage data, but also includes image manipulation data where the user has manipulated the image (such as rotating the image from the as-scanned orientation to a user-preferred orientation), titling, special effects, color rebalancing, cropping, and the like.

As shown in FIG. 3, once the HSM (D) receives the request for images, the HSM (D) retrieves (100) the image files from the appropriate storage media (42), depending on the nature of the call (e.g., TN or PV rendering to the customer, or FR for point product production. In this embodiment, the gateway server/webserver (38) is not necessarily functionally capable of determining or selecting the physical storage media or location. The webserver only sees the amount of time it takes for the HSM to provide the images. Once the file with the images is at the HSM (D), the HSM forwards (110) the file to the gateway server/webserver (38). The gateway server/webserver (38) extracts the individual image(s) from the compressed file and sends (120) each image over the Internet (16) to the customer (32-2).

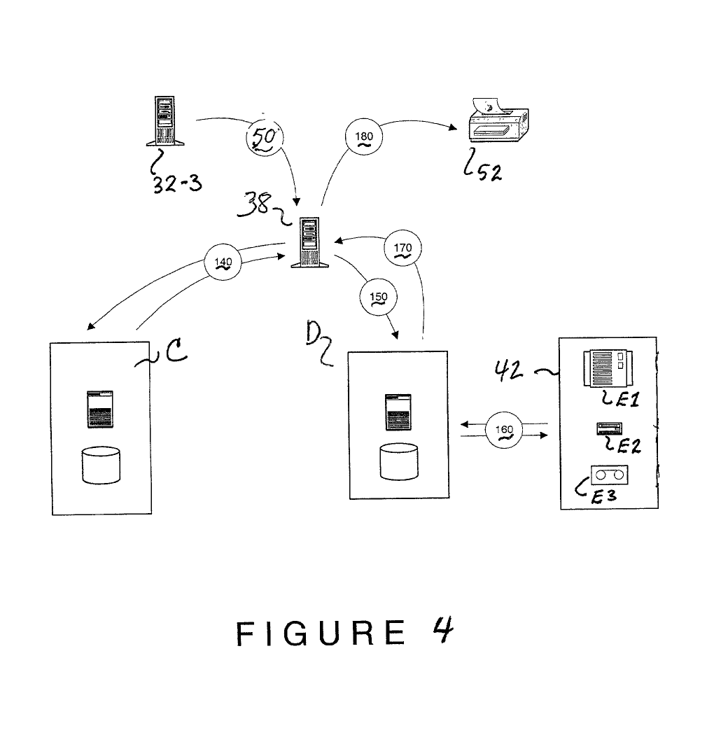

FIG. 4 shows the process through which a customer can order an image product. The order submitter (32-3) (this may be the customer, an online viewer given permission to view the customer's images, or some other order submitter) submits an order (50) to the Gateway server/production controller (38). The gateway server/production controller (38) queries the Image Database (C) to determine the file name(s) for the requested images. The Gateway server/production controller (38) forwards (150) the file names to the HSM (D), which requests (160) the specific image files needed from the image file archival storage media (42). Once the HSM receives (160) the image files, it forwards (170) those files to the gateway server/production controller (38). The production controller extracts the necessary images from the consolidated image files and prepares the images, through additional rendering and scaling, or whatever else is needed, and sends (180) the images to the final product creator (52), here a printer to make professional photo quality prints of the digital image. The product can be any product, and the example of a print is by no means limiting.

The above-described inventive software and hardware system manages the digital image files for more efficient archiving and handling. The computer system typically includes pictures on disc (POD) packer computers, servers, and storage devices, including by way of non-limiting example, POD packers, and upload- and webservers. The system typically includes high capacity archival storage computers which contain, integrally, or in distributed configuration, a plurality of different storage devices, including hard drives, CD-RW media drives, and tape drives.

In one embodiment, the full size images are distributed by the inventive image management software for selective storage on tape, as a “prime source archive” which permits direct printing of high-resolution images by commercial grade photoprinters and reconstruction of the smaller sizes, as needed in the event of loss or destruction (see FIG. 3). As described above, the prints can be packed and mailed to the customer or to his or her designee. As appropriate, the customer can cause to be forwarded the FR image files electronically. The customer can choose to forward the FR images to 3^{rd}-party affiliates of the processor (e.g., and without limitation: a web page design house, printer, ad agency, stock photo agency, and the like). The customer later can order prints of images via the Internet, which images the inventive system retrieves from the archival FR-storage files, prints, and sends to the customer's designee In the current best mode embodiment, the customer can view the images in TN, PV and SCR sizes, and can edit and create photo “Albums” (customer-created groups of images) The customer may then designate these Albums for shared viewing by anyone given a link to the images by the customer via e-mail or other communication. The customer may also be provided the option of viewing the FR images for selection and download to their own computer (see FIG. 2). The inventive system combines the selected image or images (selected via a click-box or similar means) into a tar file and sends the file to the customer via ftp protocol. The tar file can be uncompressed by the customer via a “zip” program, such as PkZip™ or WinZip™. If the customer so chooses, the customer can then send the images as normal file attachments by conventional means, such as by using an email client and attaching the compressed files to an email.

As an option, where there is a history of non-call (i.e., no viewing) by the customer of the small images, those images are removed or deleted from the faster, more expensive spinning media as the usage drops off. If there is a later view request or print order, the inventive system recreates the appropriately sized image, as required, from the archival library tape. In addition, for further redundant safety, the inventive system can incorporate the archiving of FR image files by duplicating the files and maintaining the duplicate files off-site in a separate, secure, fire-safe data archive facility.

### INDUSTRIAL APPLICABILITY

It is clear that the inventive multi-resolution digital image management process, by virtue of its efficiency of handling and archiving images in inverse hierarchical order offers significant advantages to the image processing and transfer industry.

In practice, in accord with the current best mode embodiment of the invention, the image management system stores the TN and PV images on hard disk drives to provide the fastest access, about 4 to 8 seconds. The SCR size images are stored on magneto-optical disk (like a read/write CD) with an access time of about 8 to 12 seconds. The full sized FR images are stored on tape with an access time of 30 to 60 seconds. The current best mode embodiment allows only the TN, PV, and SCR size images to be viewable on the Internet. The full size image can be downloaded or be used to print, but cannot be viewed on the Internet. In another possible embodiment, the FR images can also be viewed.

The FR consolidated image file is kept on file indefinitely. The smaller resolution files can be removed from the system after a specified period of inactivity in order to save storage space. If these smaller images are again required, they can be quickly reconstructed from the FR images by the inventive system and method.

The primary outputs from the digital process are index prints (the array of thumbnails on a photo-sized sheet), CDs, and digitally produced prints and products (52). The opportunity to save the digital images in the Archival Image Library (which is truly On-Line accessible) makes it possible to produce these items later.

Table 1 below shows the specifications of the size-to-media-storage system of the invention in the Image Library as can be realized in actual practice:

TABLE 1

| Image Type | Size | Storage (KB) | Storage Media Type |
|---|---|---|---|
| Thumbnails (TN) | 96X64 | 5.8 | Disk |
| Previews (PV) | 384X256 | 16.9 | Disk |
| Screens (SCR) | 768X512 | 126 | MO |
| Full (FR) | 1536x1024* | | Tape |

*The FR resolution may be higher, or in the case of images provided by the end user, the image size will be no greater than provided by the customer.

It will be evident to one skilled in the programming art that in view of the detailed description and figure illustrating the functionalities of the inventive system, appropriate programs and code can be easily written to realize the management of the images as called for herein. Furthermore, the specific sizes of the images may change over time as technology improves such that SCR images may become higher resolution than the FR images of today. The hierarchical storage system remains constant even if the specific resolutions of all the image types, TN, PV, SCR, and FR grow exponentially.

It should be understood that various modifications within the scope of this invention can be made by one of ordinary skill in the art without departing from the spirit thereof. We therefore wish this invention to be defined by the scope of the appended claims as broadly as the prior art will permit, and in view of the specification if need be, including equivalents thereof.

1) A method for management of multi-resolution digital images comprising the steps of:
a) acquiring a plurality of digital images of different image file sizes;
b) storing said image files on a plurality of different data storage media in inverse hierarchical order with the smallest file sizes being stored on the fastest storage media, and the largest on the slowest media;
c) managing said storage to maintain highest effective image file density on the faster media and to facilitate faster access to selected images from said image files.

2) A method as in claim 1 wherein said step of acquiring includes acquiring a full resolution digital image, and copying said full resolution digital image in lower resolution image files for storage on said data storage media.

3) A method as in claim 2 wherein said step of acquiring includes the step of consolidating
a) said acquired images in logical sets.

4) A method as in claim 1 wherein said digital image files are selected from a plurality of TN, PV, SCR, and FR digital images.

5) A method as in claim 2 wherein said digital image files are selected from a plurality of TN, PV, SCR, and FR digital images.

6) A method as in claim 5 wherein said management step includes the step of permitting limited customer access to lower resolution files for faster rendering while providing sufficient detail for customer selections for transmission and reproduction.

7) Method as in claim which includes the steps of tracking the use of the image files, discarding the low resolution files that show a preselected level of infrequent use, and recreating low resolution files from high resolution files upon a retrieval request for the images corresponding to the remaining high resolution file images.

8) At least one computer readable media on which are stored computer-executable instructions that when executed on at least one processors, perform the method of claim 1.

9) A system for management of multi-resolution digital images comprising:
a) means for acquiring a plurality of digital images of varying image file sizes;
b) means for ranking said image files by size and selectively distributing said files for storage in a plurality of different types of storage media in an inverse hierarchy, with the smaller files being grouped and stored on the fastest storage media, and the larger files being stored on the slowest media, to maintain the highest effective image density on the faster media to facilitate faster retrieval of the most commonly used image files.

10) A system as in claim 9 wherein said acquiring means includes a developed film or print scanner and a web server that facilitates receipt of digital images supplied over the Internet, and said means for ranking and distributing said image files includes computer-readable media comprising computer-executable instructions that when executed direct at least one server to carry out the selected distribution, storage and retrieval functions.

11) A system as in claim 10 which includes means for selectively tracking and deleting low resolution image files having a history of low usage, and recreating low resolution files from high resolution files upon a retrieval request for the images corresponding to the remaining high resolution file images.

12) Computer-readable media comprising a computer-executable instruction set that when executed directs at least one computing device system to manage the acquisition, consolidation, routing, storage, retrieval and rendering of sets of digital image files of differing size to and from a plurality of different data storage/retrieval media in inverse hierarchical order, with the smallest image file sizes being stored on the fastest storage media, and the largest image file sizes on the slowest media to maintain a higher effective image file density on the faster storage/retrieval media and to facilitate faster access to selected images from said image files.

13) Computer-readable media as in claim 12 wherein said managed digital image files are selected from a plurality of TN, PV, SCR, and FR digital images.

14) Computer-readable media as in claim 13 that includes instruction sets for managing a web server to facilitate receipt of digital images and orders for reproductions on various media via the Internet.

15) Computer-readable media as in claim 14 that includes instruction sets for managing at least one server to track the use of the image files, discard the low resolution files that show a preselected level of infrequent use, and recreate low resolution files from high resolution files upon a retrieval request for the images corresponding to the remaining high resolution file images.
